(19) United States
(12) Patent Application Publication
(10) Pub. No.: US 2001/0042054 A1
(43) Pub. Date: Nov. 15, 2001

(54) Postage meter machine with access protection

(76) Inventors: Klaus Dietrich, Berlin (DE); Michael Sperling, Berlin (DE)

Correspondence Address: SCHIFF HARDIN & WAITE, Patent Department, 7100 Sears Tower, 233 South Wacker Drive, Chicago, IL, 60606, US

(21) Appl. No.: 09/768,749

(22) Filed: Jan. 23, 2001

(30) Foreign Application Priority Data
Jan. 27, 2000 (DE) 100 03 309.1

(51) Int. Cl. G06F 12/14

(52) U.S. Cl. 705/405

(57) ABSTRACT

In a postage meter machine for franking postal matter and a method for protecting security functions and/or data in such a postage meter machine against unauthorized access, for repair or maintenance purpose or for loading software updates, it is still sometimes necessary that individual persons be given access to security-relevant functions and/or data such as, for example, the accounting unit or postage fee data. In order to enable this but to simultaneously preclude unauthorized persons, who could then perform manipulations at the postage meter machine, from obtaining such access, a security code that is interrogated for allowing access is encrypted in the security module, the encrypted security code is compared to an encrypted access code stored on a required storage medium, and the access to the security-relevant functions and/or data is enabled given agreement of the encrypted security code with the encrypted access code.

### BACKGROUND OF THE INVENTION

1. Field of the Invention

The present invention is directed to a postage meter machine for franking postal matter as well as to a method for protecting security-relevant functions and/or data of a postage meter machine against unauthorized access.

2. Description of the Prior Art

A postage meter machine and a method of the type are known, for example, from European Application 789 333. The postage meter machine disclosed therein is equipped with a printer for printing the postage value stamp on the postal matter, a control unit for controlling the printing and peripheral components of the postage meter machine, an accounting unit for debiting postage fees that are maintained in nonvolatile memories, and a unit for cryptographic securing the postage fee data. The accounting unit and/or the unit for securing the printing of the postage fee data can be realized with a security module.

Postage meter machines can be independent, specific devices, but conventional computers equipped with specific hardware and software are increasingly being employed as franking machines. Security modules for postage meter machines can be realized as multi-chip modules orone-chip systems (for example, chip cards). They are integrated with the postage meter machine, or are pluggable or are connectable to the postage meter machine as external device.

For protecting security functions and/or data such as, for example, the accounting function, the postage fee data or cryptographic keys that are employed, it is known to employ an OTP (one-time programmable) processor in the security module in which sensitive data are stored in a manner protected against readout. Moreover, the security module can be encapsulated in a tamper-proof security housing.

There are, however, situations wherein it is necessary to provide specific persons with access to all or to specific security functions and/or data. This is required, for example, for repair or maintenance work, for entering new software or for other service purposes. However, it must be reliably assured that only the authorized persons have such access.

German Published Application 36 27 124 discloses a postage meter machine wherein a password is interrogated before use for securing the operations. The passwords of various users are stored in the postage meter machine and, upon input of a password, this is compared to the stored passwords. Enabling of the postage meter machine for franking only ensues when the input password coincides with the stored password.

A disadvantage of such known postage meter machine, however, is that a person merely has to get possession of a password in order to enable frankings. This, however, is not suited as a protection mechanism for security-relevant functions and/or data of a postage meter machine, since the risk is high that a person can get possession of a password.

### SUMMARY OF THE INVENTION

An object of the present invention is to provide a method for serving a postage meter machine, as well as a postage meter machine operating according to the method, wherein the probability is high that only authorized persons have access to security functions and/or data.

The above object is achieved in accordance with the invention in a postage meter machine, and in a method for operating postage meter machine, wherein security functions and/or security of the postage meter machine are protected against unauthorized access by providing a security module wherein an encrypted security code is compared to an encrypted access code. The access code is stored on a storage medium which must be present in the postage meter machine, such as by being inserted into a reader unit, in order to supply the access code to the security module. Access to security functions and/or security data is enabled only if the encrypted security code agrees with the encrypted access code.

The invention is based on the use of a two-tiered security measures for access to security functions. In order to obtain the desired access, a security code that is encrypted in the security module must first be entered and, second, a storage medium, for example a diskette or a chip card, must be present on which an access code that has already been encrypted is stored. This storage medium must likewise be supplied to the reader unit so that the access code, that is stored encrypted therein can be read in a way that is invisible to the user, this access code being subsequently compared to the encrypted security code. The requested access is enabled only when these two codes agree. Neither having the security code by itself nor having a storage medium with the encrypted access code stored thereon by itself suffices to gain access. It is not possible to achieve such an access either based solely on the unencrypted security code or based solely on the encrypted access code, which cannot be read out at all by a user under normal circumstances. Without knowledge of the encryption algorithm, it is not possible to develop the encrypted access code from the unencrypted security code in order to store it on a storage medium, nor is it possible to develop the unencrypted security code from the encrypted access code if one were to succeed in reading it out from a storage medium. Additional protection is assured in that the security cod—in its unencrypted condition—is stored neither in the postage meter machine, as is the case in German Published Application 36 27 124, nor in the required storage medium.

The invention thus offers effective protection against unauthorized accesses to security functions and/or data. Only a person who knows a specific security code and has possession of a storage medium with the appertaining access code stored therein can receive the desired access in the inventive postage meter machine. The corresponding security codes and access codes or the corresponding encryption are thereby assigned by a central security authority, for example a postal service, that also has the encryption algorithm and stores the encrypted access code on a storage medium. Service programs, diagnosis data, software updates or the like can also be stored in such a storage medium.

The access can be limited to specific functions and/or data of the postage meter machine with the security and the access code. To that end, the central security authority can establish a number of security codes with appertaining access codes to which respectively different access authorizations are allocated.

In an embodiment of the invention a user identifier and a user password are used as the security code, whereby the user name is preferably employed as user identifier. Given a desired access to the postage meter machine, the user identifier and user password are then entered via an operating unit, comparable to the logon event in a computer network. In a version of this embodiment, the user password—which is stored neither in the postage meter machine nor on the storage medium—is employed as the key for the encryption of the security code that occurs in the security module. Each user wishing to obtain access to security functions and/or data of a postage meter machine thus has a separate key.

In a further embodiment the security module is equipped with a standard encryption algorithm for the encryption of the security code. This, for example, can be a DES algorithm (DES=data encryption standard) as described in “Angewandte Kryptografie-Protokolle, Algorithmen und Sourcecode in C”, Bruce Schneier, Addison-Wesley.

In a preferred embodiment the encrypted access code is contained in every storage medium with which security-relevant functions and/or data are to be read, written, deleted and/or modified. This further enhances the protection against unauthorized or unintentional manipulations of a postage meter machine. Thus, for even if a person somehow obtains possession of the security code and a storage medium with appertaining, encrypted access code, and thus can get access to the postage meter machine, the accounting software or accounting data still cannot be copied on a further storage medium nor can this software or data be manipulated or overwritten.

### DESCRIPTION OF THE DRAWINGS

FIG. 1 is a block diagram of an inventive postage meter machine.

FIG. 2 is a schematic illustration form explaining the invention.

### DESCRIPTION OF THE PREFERRED EMBODIMENTS

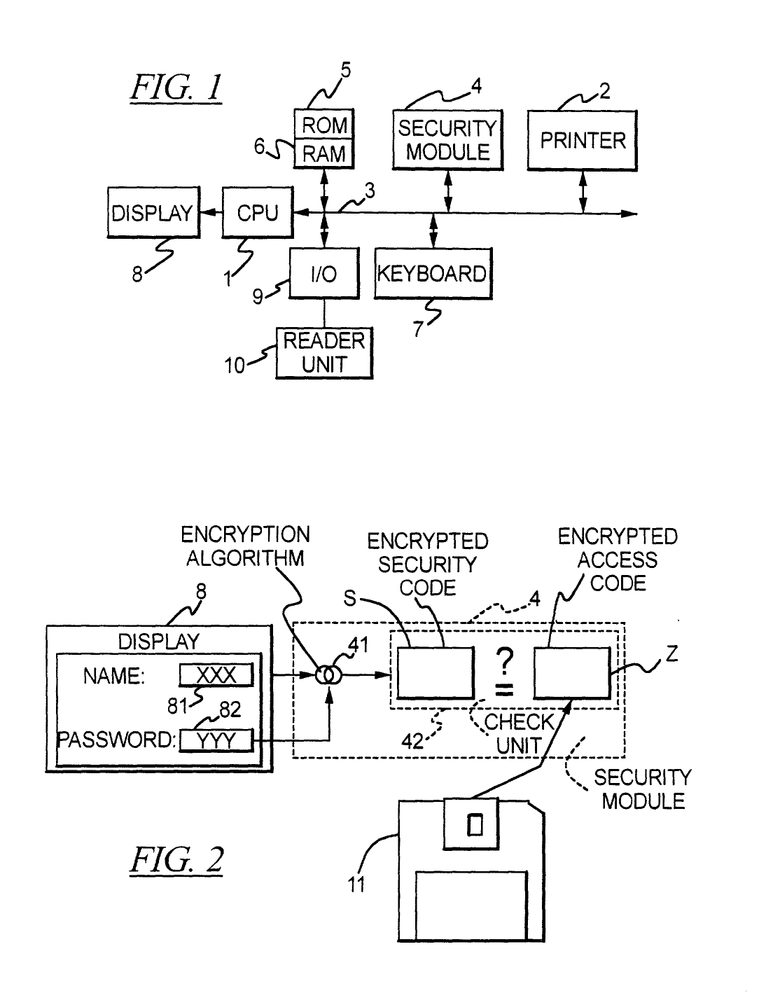

FIG. 1 shows a block circuit diagram of an inventive postage meter machine with the basic function units. A control unit 1, for example a central microprocessor (CPU), controls the printing of postage value stamps, which ensues with a printer 2. The control unit 1 is connected to a security module 4 and to a printer 2 via a control bus 3 that contains address, data and control lines.

Further, the control unit 1 is connected to a non-volatile memory 5 and to a main memory 6 via the control bus 3. A central control program for the control unit 1 is deposited in the memory 5 as command sequence. Moreover, masters for compiling the print format of the postage value stamp are stored in the memory 5. The control unit 1 loads the desired master into the main memory 6 and processes the master according to the inputs of an operator. The desired print format is generated according to these inputs, which also include the input of the postage value, which is stored in the main memory 6.

The operator can operate the postage meter machine and, for example, prescribe the print image via a keyboard 7 connected to the control bus 3. A display 8 driven by the control unit 1 informs the operator about the executive sequences in the postage meter machine. An input/output unit 9 is connected to a reader unit 10 that, for example, can be a disk drive, a chip card reader or some other unit for accepting and reading a storage medium. Moreover, the input/output unit 9 is connected to drive elements (not shown) of the postage meter machine and to sensors that monitor the status of the postage meter machine. A transport and weighing system (not shown) for the postal matter also can be connected thereto.

The security module 4 essentially comprises an accounting unit and an encryption unit. Let the aforementioned EP 789 333 A2 be referenced in view of the functioning and structure of the accounting unit.

The functioning of the invention shall be described in greater detail on the basis of FIG. 2. When a person, for example a service technician, must have access to security-relevant functions and/or data, for example to the accounting unit or accounting data, because of a malfunction of the postage meter machine, then the following events sequence given an inventive postage meter machine: First, the person is prompted on the display 8 to enter name and password in the input fields 81, 82 as a security code. The encrypted security code S is formed from the input data with an encryption algorithm 41 that is installed and runs on the security module 4 and is supplied to a check unit 42. Moreover, a storage medium, a diskette 11 in the example, on which an encrypted access code Z is stored, must be placed in the reader unit 10. This is read out from the diskette 11 and likewise supplied to the check unit 42. A comparison of the encrypted security code S to the encrypted access code Z then ensues. Given a coincidence, the access is subsequently enabled, whereas access is denied given non-coincidence. The access also is denied when the name 81 and/or the password 82 is wrong or does not belong to the access code stored on the diskette 11. Access is also not possible given a missing diskette 11.

The postage meter machine can be fashioned such that the access is only enabled as long as the storage medium 11 is introduced into the reader unit 10. To this end, for example, the encrypted access code Z is repeatedly read from the diskette 11 at regular time intervals and compared to the security code S. This precludes access still being possible when the authorized person has in fact gone away from the postage meter machine and also removed the diskette, but the name 81 and the password 82 are still entered.

As can be immediately seen, the inventive postage meter machine and the inventive method can be fashioned differently from the embodiment shown in the figures. For example, a storage medium other than a diskette can be employed for storing the encrypted access code Z, and the security code need not necessarily be composed of name and password. The realization of the franking machine advantageously ensues on a commercially available PC with connected printer and with potentially additional hardware components.

Although modifications and changes may be suggested by those skilled in the art, it is the intention of the inventors to embody within the patent warranted hereon all changes and modifications as reasonably and properly come within the scope of their contribution to the art.

We claim as our invention:

1. A postage meter machine for franking postal items, comprising:
a control unit for controlling at least one component for printing a postage imprint on an item, said control unit having access to at least one item of security information selected from the group consisting of security functions and security data for use in controlling at least one component;
a storage medium having an encrypted access code stored thereon;
a reader unit which interacts with said storage medium to read said encrypted access code therefrom;
an input unit for entering an unencrypted security code; and
a security module in communication with said control unit, said reader unit and said input unit, said security module having an encryption algorithm stored therein for encrypting said unencrypted security code to produce an encrypted security code, and a comparison unit for comparing said encrypted security code to said encrypted access code, said security module allowing access by said control unit to said security information only if said encrypted security code agrees with said encrypted access code in said comparison unit.

2. A postage meter machine as claimed in claim 1 wherein said security module forms said encrypted security code from a user identification and a user password entered through said input unit.

3. A postage meter machine as claimed in claim 2 wherein said security module employs said user password as a key in said encryption algorithm for encrypting said user identification to form said encrypted security code.

4. A postage meter machine as claimed in claim 1 wherein said security module employs a standard encryption algorithm as said encryption algorithm.

5. A postage meter machine as claimed in claim 1 wherein said control unit operates in combination with said storage medium for performing procedures selected from the group consisting of reading said security information, writing said security information, deleting said security information and modifying said security information, and wherein a storage medium having said encrypted access code is required in said reader for allowing said control unit to perform said procedures.

6. A method for protecting security information in a postage meter machine against unauthorized access comprising the steps of:
controlling at least a printer with a control unit, for printing a postage imprint, and making use of security information in said control unit for controlling at least said printer;
entering an unencrypted security code into said postage meter machine;
storing an encrypted access code on a storage medium separable from said postage meter machine;
interacting said storage medium with a reader unit to read said encrypted access code therefrom into said postage meter machine;
encrypting said unencrypted security code to form an encrypted security code in a security module;
supplying said encrypted access code from said reader unit to said security module and, in said security module, comparing said encrypted security code with said encrypted access code; and
allowing said control unit access to said security information only if said security module determines that said encrypted access code agrees with said encrypted security code.

7. A method as claimed in claim 6 comprising entering a user identification and a user password into said postage meter machine and, in said security module, producing said encrypted security code by operating on said user identification with an encryption algorithm using said user password as an encryption key.

8. A method as claimed in claim 7 comprising using a standard encryption algorithm as said encryption algorithm.
